(19) United States
(12) Patent Application Publication
(10) Pub. No.: US 2015/0062448 A1
(43) Pub. Date: Mar. 5, 2015

(54) TOUCH SCREEN DISPLAYS

(71) Applicant: Arvind S., Bangalore (IN)

(72) Inventor: Arvind S., Bangalore (IN)

(21) Appl. No.: 14/015,016

(22) Filed: Aug. 30, 2013

(51) Int. Cl. G06F 1/16

(52) U.S. Cl. CPC G06F 1/169
USPC 349/12; 156/60

(57) ABSTRACT

An apparatus and system for a touchscreen display is provided. In an example, a computing device includes a display panel cover permanently bonded to a sensor panel, wherein the display panel cover is a scratch resistant plastic material, and the sensor panel includes a touch sensor that can detect at least 15 simultaneous touch inputs on the display cover.

### TECHNICAL FIELD

The present techniques relate generally to transparent display covers and technologies for bonding the covers to touch sensing technology.

### BACKGROUND ART

For many computer systems, such as all-in-one computer systems, the display is the most visible and important component. Large and bright displays use substantial amounts of power and can be both thick and heavy. However, these characteristics can make a portable system difficult to implement. Further, many systems can track only a limited number of touch inputs on the screen or a single stylus input.

### BRIEF DESCRIPTION OF THE DRAWINGS

FIG. 1 is a drawing of a device having a touchscreen display.

FIG. 2 is a side sectional view of a laminated display stack used to form a display panel.

FIG. 3 is a side sectional view of another display stack showing thicknesses of layers that may be used in one example.

FIG. 4 is a block diagram of a device using the touchscreen technologies described herein.

FIG. 5 is a method for forming a display stack for a touch screen display.

FIG. 6 is a process flow diagram of a method for tracking of inputs from the sensors described herein.

FIG. 7 is a drawing of an all-in-one computer showing multiple touch input on the display.

FIG. 8 is a drawing of a display with a large touch screen.

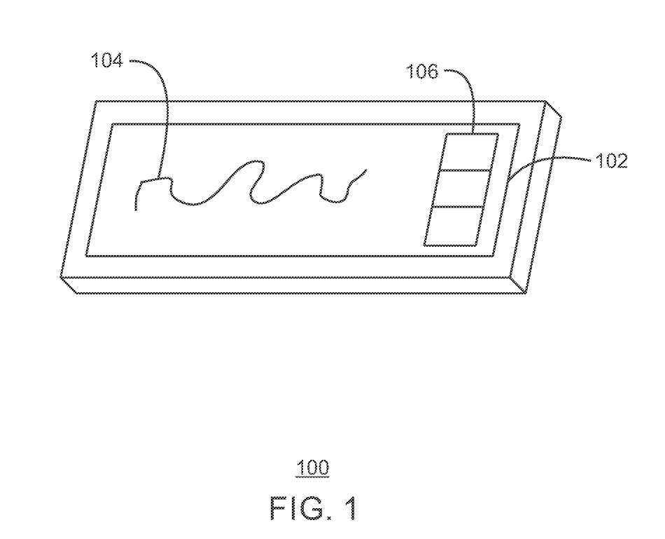

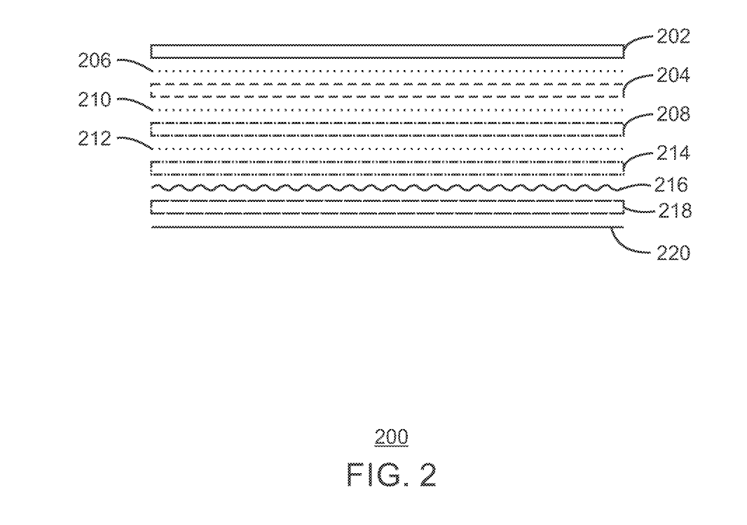

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In order to make portable all-in-one (pAIO) computer systems practical, systems may have a weight target of less than about four kilograms, a thickness of less than about 2.2 cm, and a battery life of more than about 6 to 8 active hours. Further, to enable collaboration applications that have multiple users, a touch detection of about 20 points or more, e.g., with a high report rate for a good response, is useful. For systems that use a stylus, a detection system enabling the use of multiple active styluses, integrated with the display, may also provide improved functionality.

To implement these functions, the display itself can be engineered to achieve various targets, as described herein. For example, the display may be large, for example, with a diagonal measurement that is greater than about 50 cm (about 22″). The display can have a resolution that is full high definition resolution, e.g., at about 94 pixels per inch (PPI). The touch sensor can also be high resolution, e.g., detecting about 20 points simultaneously. Further, the display can be used with styluses, and may implement multiple stylus and touch detection simultaneously. To be used in portable All-In-One (pAIO) computers, the displays described herein can have a low power consumption, for example, less than about 7 W for 200 candelas per square meter (cd/m², also termed “nits”). Further, the techniques described herein allow the display to have very low weight, e.g., less than about 0.7 kg (about 1.5 lbs.).

Current systems often use glass panels for the display panel covers to increase scratch resistance. However, at larger screen sizes, the use of glass may increase the weight to impractical levels. Various types of scratch resistant plastics can be used to improve the weight of pAIO systems. For example, polymethylmethacrylate (PMMA), polycarbonate (PC), and other polymers may be useful as lighter weight display panel covers. In some cases, the polymers may be used with an added scratch resistant coating.

The display panel cover may be directly bonded to a sensor grid, which can provide support. As a result a hard grade of PMMA, in spite of higher brittleness, may be used, improving the user experience while maintaining a scratch resistant surface. The use of PMMA may also lower display power, since more light may be transmitted through the panel. Further, enhancements to brightness enhancing films (BEF), often used between the light source and a liquid crystal display (LCD) display panel, may also lead to enhanced battery life.

In some embodiments, the touch panel design can provide for a twenty point touch or more with a 200 hertz report rate, including at large screen sizes. In addition to, or instead of, the touch sensor, the displays may also integrate a stylus antenna capable of detecting multiple stylus inputs. In one embodiment, substantially simultaneous touch input and stylus input are used.

FIG. 1 is a drawing of a device 100 having a touchscreen display 102. The touchscreen display 102 allows the user to interact with the device 100, for example, by free form input 104 or the selection of virtual controls 106, among many others. As used herein, any display of freeform input 104 shown also includes all other kinds of touch input that may be used to interact with the device.

The device 100 can be a smartphone, a personal digital assistant, a tablet, a laptop, a pAIO, an AIO computer, a computer monitor, a television system, or any number of other devices 100 that currently have, or may benefit from, a touchscreen display 102. For example, other devices 100 could include medical devices, process control computers, and the like. In some embodiments, the devices have large display formats, including touchscreen displays 102 that are greater than about 56 cm (about 22 inch) in diagonal, about 69 cm (about 27 in), about 132 cm (about 52 in), or even larger. As noted previously, in embodiments described herein, the display panel cover may use a PMMA plastic in place of glass or other materials, lowering the weight of the unit.

FIG. 2 is a side sectional view of a laminated display stack used to form a display panel 200. The display panel 200 has a display panel cover 202 over the top of the structure to protect the component. As described herein, the display panel cover 202 may be a scratch resistant plastic material, such as a PMMA, a PC, or other material, either alone or in a laminated structure, such as a scratch resistant coating.

In some embodiments described herein, direct bonding techniques can be used to form larger displays. For example, the display cover panel can be attached to a touchscreen sensor 204 by an adhesive layer 206. In one embodiment, the touchscreen sensor 204 is a metal mesh as described herein. In addition to sensing touch, the metal mesh can provide mechanical support to the display panel cover 202, e.g., the PMMA, allowing the formation of a stiffer display and the use of more brittle and scratch resistant plastic grades.

A stylus antenna 208 can be attached to, and insulated from, the touchscreen sensor 204 by a second layer 210 of adhesive. In embodiments described herein, the stylus antenna 208 can be used to accept input from two styluses at once. This can be performed by an antenna driver using six frequency bands to register the inputs from both styluses. More frequencies can be added to increase the number of styluses used. In some examples, input is accepted from both a stylus and touch points. A separate stylus antenna 208 may not be needed as the touchscreen sensor 204 can be used as both a touch sensor and a stylus antenna. In these examples, the stylus antenna 208 and second layer 210 of adhesive would be eliminated.

Another layer 212 of adhesive, as described herein, can be used to fix the layers above to a display panel 214. The display panel 214 can be an LCD panel or an OLED panel, as known in the art. If an OLED panel is used, no further layers are needed. If an LCD panel is used as the display panel 214, it may include multiple layers, such as a top polarizer, a conducting film (CF) glass, a thin-film transistor (TFT) panel, another CF glass, and a bottom polarizer, among others.

Further, if the display panel 214 is an LCD panel, additional layers are used below the display panel 214 to light the panel and increase the brightness. For example, a brightness enhancement film (BEF) 216 can be placed behind the display panel to increase the light sent through the panel. The BEF 216 can be a prismatic film that directs more light through the display panel. Further, the BEF 216 can include a dual BEF (dBEF) that directs light in two directions, improving the readable angles of the device. Multiple layers and combinations of these films can be used as the BEF 216. A light source 218, such as a light guide that is illuminated by a light emitting diode (LED) array or fluorescent tubes, can be placed behind the BEF 216 to provide illumination for the display panel 214. A reflector 220 can be placed behind the light source to increase the amount of light that passes through the display panel 214. The design of the reflector 220 and the BEF 216 can be selected to make the light passing through the display panel 214 more diffuse and directionally aligned, decreasing any light variations, and increasing the efficiency. Integration of the BEF 220 and any additional overlays along with a reflector 220 may increase display brightness and efficiency of an LED backlight by as much as about 45% or more.

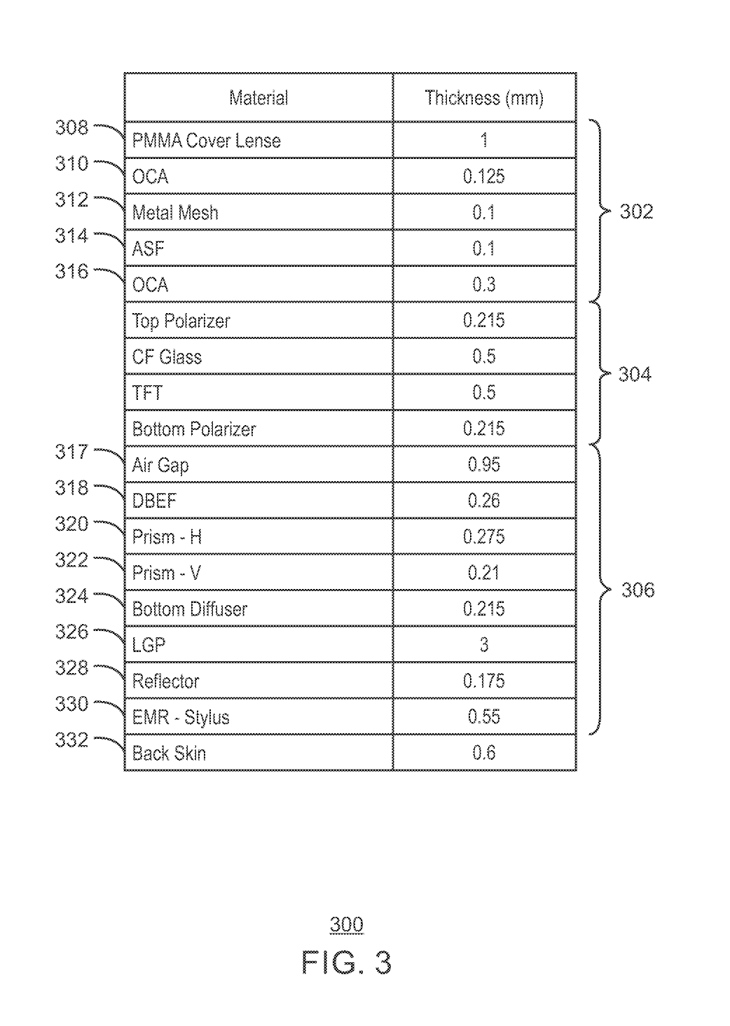

FIG. 3 is a side sectional view of another display stack 300 showing thicknesses of layers that may be used in one example. The display stack can be divided into three general parts, an outer stack 302, a display stack 304, and a lighting stack 306. The outer stack 302 can include a number of layers selected to protect the display and detect touch inputs, stylus inputs, or both.

In the example shown in FIG. 3, the display cover 308 is a PMMA that is about 1 mm thick. PMMA can include blend of several related resins, allowing the properties, clarity, stiffness, scratch resistance, and brittleness, to be selected for the application. Many PMMA grades have high optical clarity and about half the weight of display glass. Although scratch resistance can be high, many PMMA resins that offer high surface hardness are also brittle. Thus, a careful choice of PMMA grades has to be made to balance surface hardness and impact resistance (brittleness). Many of these grade may have a relatively high glass transition temperature (Tg), leading to increased brittleness at low temperatures. The PMMA grade may be selected to be is optically superior as compared to display glass. For example, the PMMA is 93% clear as compared to 88% for a display glass. The use of a high clarity PMMA grade results in a power reduction of about 5% in comparison to the display glass. The use of direct bonding techniques to affix subsequent layers to the display cover 308 allows the select of harder grades, since the attached components provide reinforcement.

A layer of optically clear adhesive (OCA) 310 can be attached to the inner side of the display cover 308. The OCA 310 can be provided in the form of a tape or web that has adhesive layers on each side of a reinforcing film. Further, the OCA 310 can include any number of other substantially transparent adhesives, such as a softened layer of plastic, a solvent used to soften the display panel cover 308, a light activated optically clear adhesive (LOCA), such as a gelled acrylic monomer with an ultraviolet initiator, or any number of other adhesives known in the art.

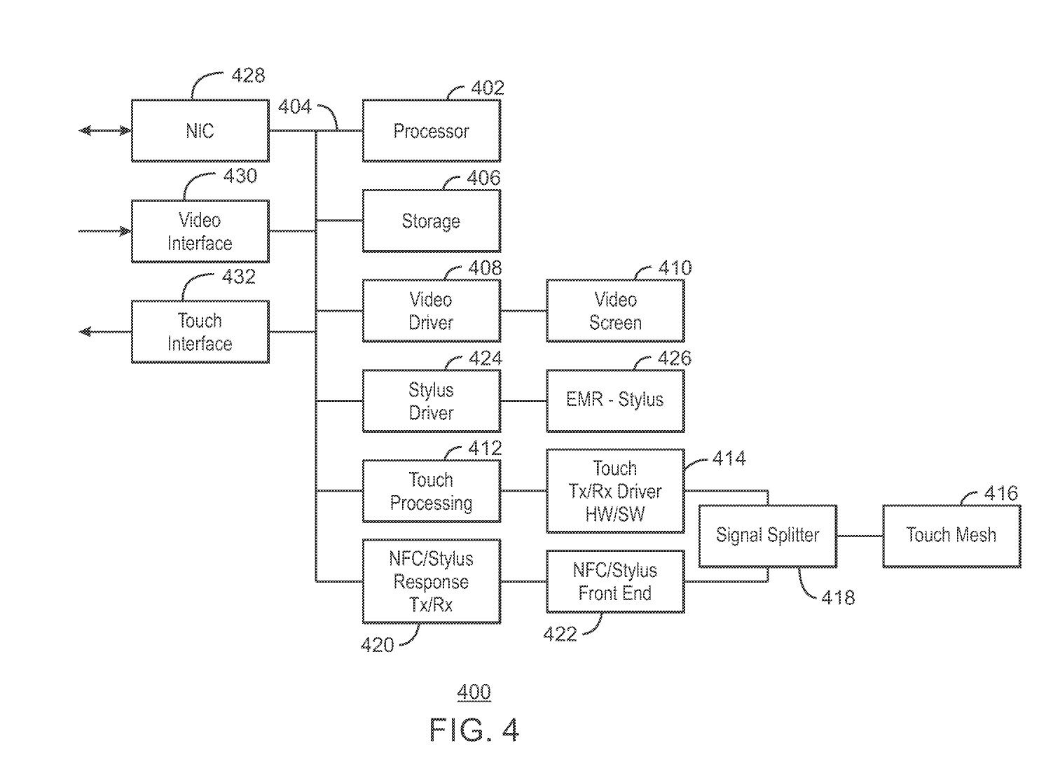

A metal mesh 312 used for registering touch, and, in some examples, stylus inputs, can be attached to the display cover 308 by the OCA 310. The metal mesh 312 can be one or more photographic film layers with a polyethylene terphalate (PET) substrate, in which the silver halide traces are formed using photographic techniques. The conducting traces of the metal mesh 312 wires can be spaced at about 30 microns with about 30 microns separating each wire. The wires in each direction are perpendicular and detect touch by capacitance. The metal mesh 312 can have a drive circuitry, as discussed with respect to FIG. 4, that provides a reporting rate of about 200 hertz (Hz), or more, enabling the tracking of about 15, about 20, about 40, or more simultaneous touch points. However, higher reporting rates can use higher currents, as the detector is capacitive. Thus, to save energy, the drive circuitry may only use higher scan rates in the vicinity of previously detected touches, when multiple touches are detected, or both. The PET substrate can function as an anti-shatter film (ASF) 314, providing reinforcement to the display cover 308. Another layer of optically clear adhesive (OCA) 316 can be used to attach the outer layer 302 to the display stack 304.

The components of the display stack 304 are known in the art, and can include, for example, any number of layers used to produce an image. For example, as shown in FIG. 3, the display stack 304 can include a top polarizer, a color filter (CF) glass, a thin film transistor (TFT) panel, and a bottom polarizer. An air gap 317 may be left between the display panel 304 and the lighting layer 306.

The air gap 317, which can be placed between a dual brightness enhancing film (DBEF) 318 and the display stack 304, increases the light scattered from the DBEF 318 prior to the display layer 304, which can increases the uniformity and brightness of the illumination. The DBEF 318 acts to improve the efficiency of panel. For example, the DBEF 318 can be a reflective polarizer that uses a multi-layer optical film technology to recycle light that would normally be absorbed by the bottom polarizer of the liquid crystal panel. Thus, the backlight efficiency is increased while maintaining viewing angle.

Two layers of prism films 320 and 322 may be used to redirect shallow angle light from a light source towards the display 304. The prism film is a polymer film that has a prismatic surface pattern. The pattern appears as a series of triangles pointing out from the flat film surface. The patterns redirect shallow light from the backlight toward the display panel 304, increasing the efficiency of the illumination. Multiple prism films can be used to further increase the efficiency, for example, mounted with the axes perpendicular to each other, e.g., providing a horizontal prism layer 320 and a vertical prism layer 322. A bottom diffuser 324 can be used to scatter the light to the prism films 320 and 322, evening out light that may have originated from discrete points, such as light emitting diodes (LEDs) or lines, such as fluorescent tubes.

A light guide plate (LGP) 326 may include the light sources, for example, mounted along an edge or the bottom. The LGP 326 can be, for example, a PMMA plate that has been etched or pattered to scatter light. In some examples, the LGP 326 can include particles configured to scatter light. The light source (included in the LGP 326) can include white LEDs, fluorescent tubes, or any number of other systems. A reflector 328 can be mounted behind the light source to redirect light back towards the display layer 304. The reflector 328 can be a metallic film, a white surface, or a more advanced material. In an example, the reflector 328 is a multilayer polymer film designed to use total internal reflectance to reflect greater than about 98% of all light emitted towards the reflector back towards the display layer 304. The combination of the prism films 320 and 322, the DBEF 318, and the reflector 328, can increase the display efficiency by about 35˜40%.

In the display stack 300 shown, a stylus antenna 330 is also present. The stylus antenna 330 can use any number of technologies to detect location and inputs from one or more styluses. For example, the stylus antenna 330 shown can use an electromagnetic resonance (EMR) sensor.

It can be noted that the stack is not limited to the layers shown, and additional layers may be added for particular implementations. For example, a scratch resistant polymer film may be applied over the top surface of the display cover 308. This film may also reduce reflections and glare from the surface of the screen. In some examples, layers may be omitted. For example, the stylus antenna 330 may not be needed if the metal mesh 312 is configured to detect both touch and stylus input, as described with respect to FIG. 4.

FIG. 4 is a block diagram of a device 400 using the touchscreen technologies described herein. The device 400 includes a processor 402 coupled to a number of other functional units by a bus 404. The processor 402 can be a single core processor, a multicore processor, or any number of other technologies, for example, if the device 400 is a portable all-in-one computer (pAIO). If the device 400 is a display configured to be used with a separate computer, the processor 402 may be an application specific integrated circuit (ASIC), a microcontroller, or other type.

The bus 404 can include any number of technologies, such as ISA, EISA, PCI, PCIe, proprietary bus technologies, and the like. The bus 404 can couple the processor 402 to a storage system 406. The storage system 406 can include any combinations of random access memory (RAM), read only memory (ROM), solid state drives (SSD), hard drives, optical drives, and the like. In an example, the storage system 406 holds programs that direct the processor 402 to obtain touch input, stylus input, or both.

A video driver 408 is coupled to the bus 404 to allow the processor 402 to display information on the video screen 410, such as the display layer 304 discussed with respect to FIG. 3. The information displayed can include reactions to a touch input, for example, provided to the processor 402 over the bus 404 from a touch processing unit 412.

The touch processing unit 412 is coupled to a touch transmitter and receiver unit 414 that implements the scanning of the lines on the touch mesh 416. The touch mesh 416 may be, for example, the metal mesh 312 discussed with respect to FIG. 3. In some examples, the scanning may be continuously performed at a first, slower, background rate to save battery power, such 50 hertz (Hz). Upon the detection of a touch, instructions stored in the storage system 406 may direct the processor 402 to have the touch transmitter and receiver unit 414 increase the scan speed to a higher rate to increase the accuracy and allow the detection of multiple touches, such as 200 Hz. The increased scan rate may be implemented across the entire panel, or may be only implemented for lines that are in the vicinity of detected touches. For example, lines that bracket the touch horizontally and vertically may be scanned at the increased rate, while lines that are not close to the touch may be scanned at the lower rate. Further, the increased scan rate can allow the detection of multiple simultaneous touches, such as 10 touches, 15 touches, 20 touches, or more.

The touch mesh 416 can also be used as a stylus antenna, for example, using a signal splitter 418 to separate the touch signals from the stylus location and input signals. In this example, a stylus response unit 420 would be coupled to the bus 404 to provide the inputs from the styluses, while a stylus front end 422 would receive the signals from the signal splitter 418 that correspond to inputs from a stylus. The location information for the stylus may be determined from the location of the received radio signal from the stylus, with respect to the lines of the metal mesh. In other examples, a hybrid system may be used, in which the stylus inputs could be received through the stylus front end 422, while the stylus location could be determined by the touch transmitter and receiver unit 414. The stylus inputs may also be obtained from a separate system, such as the EMR stylus antenna 330 discussed with respect to FIG. 3. In this example, a stylus driver 424 provides an interface between the bus 404 and the EMR stylus antenna 426. The stylus interfaces can be configured to receive multiple frequencies simultaneously to allow the use of multiple styluses. For example, the stylus interfaces can be configured to receive six different frequency inputs, allowing the use of two styluses simultaneously. Further, the device 400 can be configured to accept both touch and stylus inputs simultaneously.

The device 400 may also have any number of units to interface with external equipment and systems. For example, a pAIO may have a network interface card (NIC) 428 coupled to the bus. The NIC 428 may include a wireless interface, such as a WIFI, a standard Ethernet interface, a wide area LAN interface, such as a mobile data interface, or any combinations thereof. In an example, the device 400 may also be configured to provide touch and stylus inputs to an external computer system. In this application, a video interface 430 can receive video signals from the external computer, for example, over an HDMI or a DVI type cable. Further, a touch interface 432 can provide touch and stylus inputs to the external computer, for example, over a USB cable.

The device 400 is not limited to the configuration shown in FIG. 4, but can include or omit various systems, depending on the implementation. For example, a pAIO computer system may not include the video interface 430 or touch interface 432, since all operations may be internal. Further, in some examples, the EMR stylus driver 424 may be eliminated in the display stack does not have an EMR antenna 426. Other systems may be also be added. For example, a USB interface may be included to allow other peripheral devices, such as a keyboard, to be attached.

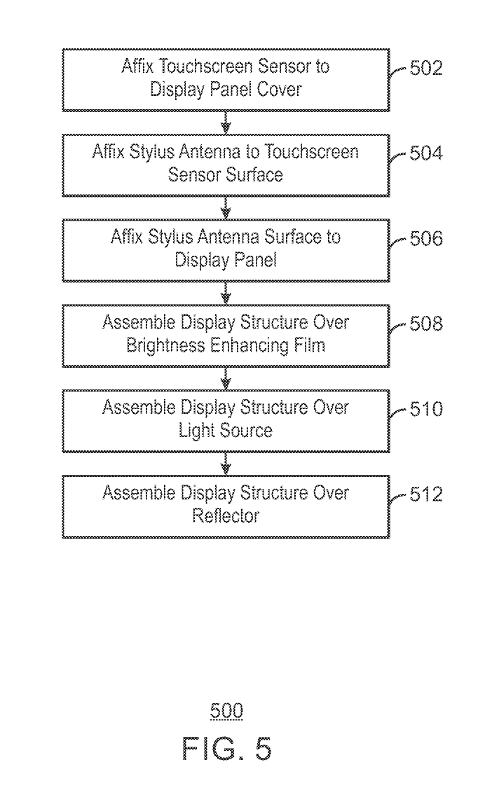

FIG. 5 is a method 500 for forming a display stack for a touch screen display. The method 500 begins at block 502 when a touchscreen sensor is affixed to a display panel cover, for example, by applying an adhesive layer over one surface of the display panel cover, then affixing the touchscreen sensor to the adhesive. At block 504, a stylus antenna is affixed to the touchscreen sensor to form a three layer structure, for example, using another layer of adhesive. At block 506, the stylus antenna surface is affixed to a display panel. The layered structure can then be assembled, as indicated at block 508, over a BEF, a prism film, a dBEF film, or any combinations thereof. At block 510, the assembled structure is placed over a light source. At block 512, the assembled structure is place over a reflective film. The final structure may be as shown in FIG. 2 or 3. In some examples, more or fewer layers are included in the structure.

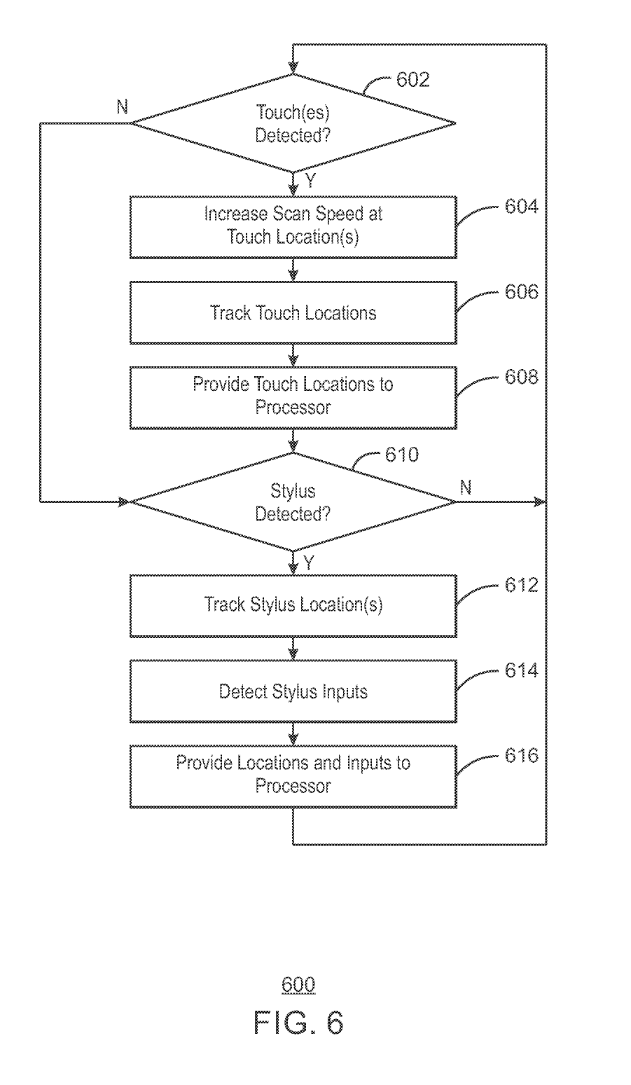

FIG. 6 is a process flow diagram of a method 600 for tracking of inputs from the sensors described herein. The method 600 can be implemented, for example, using the display stacks 200 and 300 discussed with respect to FIGS. 2 and 3, and the device 400 discussed with respect to FIG. 4. The method 600 begins at block 602 with a determination as to whether touch inputs have been detected. The detection may be performed as a query from a processor, or as an interrupt signal sent from a touch sensor.

If a touch is detected at block 602, process flow proceeds to block 604, at which the scan speed can be increased, for example, in the vicinity of the touch, or across the entire screen. At block 606, the locations of the touches are tracked, and, at block 608, the touch locations are provided to the processor. For example, the tracking may be performed by the processor using the touch sensor over time to determine a new position for each touch input.

Process flow then proceeds to block 610 to determine if a stylus input has been detected. As for the touch detection, this may be performed by an interrupt or by the processor regularly checking for the presence of the input. If a stylus input is detected, at block 612 the stylus location is tracked, for example, by the processor using the stylus sensor to determine a new location for the stylus over time. At block 614, stylus inputs are detected. This may include the initial button, or stylus input, that instructs the device to track the stylus location and respond, as well as any additional inputs from other stylus buttons. At block 616, the locations and inputs from the one or more styluses being tracked are provided to the processor.

Although the method 600 is shown as a continuous flow, it can be understood that an interrupt based system may include code that is not accessed until an interrupt is received. For example, blocks 602-608 may only be accessed if the touch sensor provides and interrupt to the processor to inform the processor that touch input data is being received. Similarly, the stylus functions in blocks 610-616 may only be accessed if an interrupt is received to inform the processor that a stylus is being used.

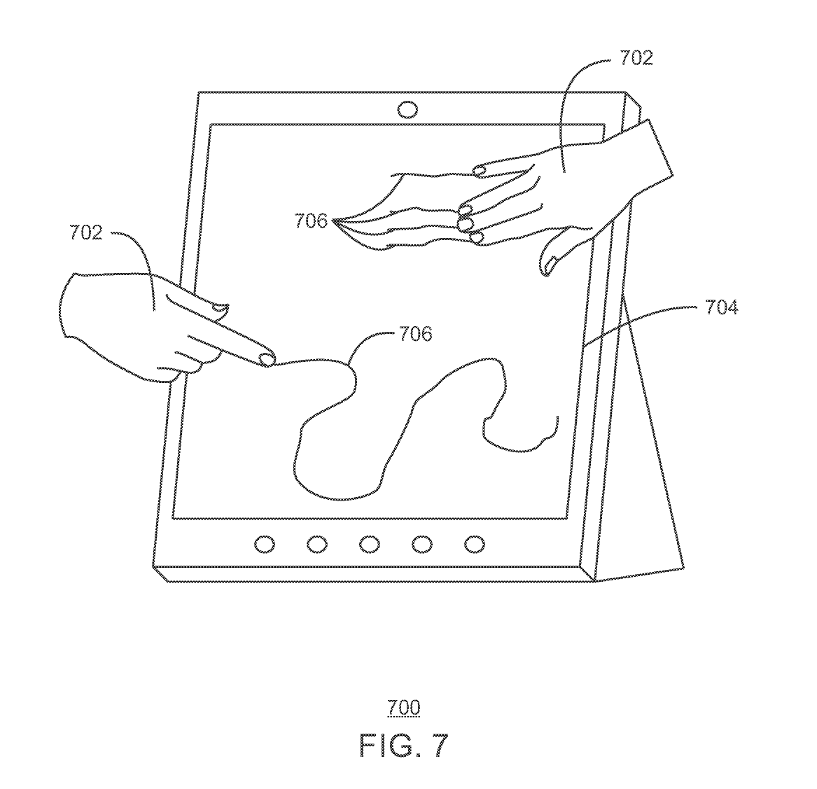

FIG. 7 is a drawing of an all-in-one computer 700 showing multiple touch inputs 702 on the display 704. The system described herein can track a number of separate touch inputs 702, with each touch input 702 controlling a different response 706 in the device. In some embodiments, the device may track about 15 substantially simultaneous touch inputs 702, about 20 substantially simultaneous touch inputs 702, about 40 substantially simultaneous touch inputs 702, or more. The devices are not limited to touch inputs, but may also take inputs from styluses. The all-in-one computer 700 may be a portable computer, for example, of 50 cm or less in diagonal screen size. However, the system is not limited to small size screens, but may be used with much larger screen sizes.

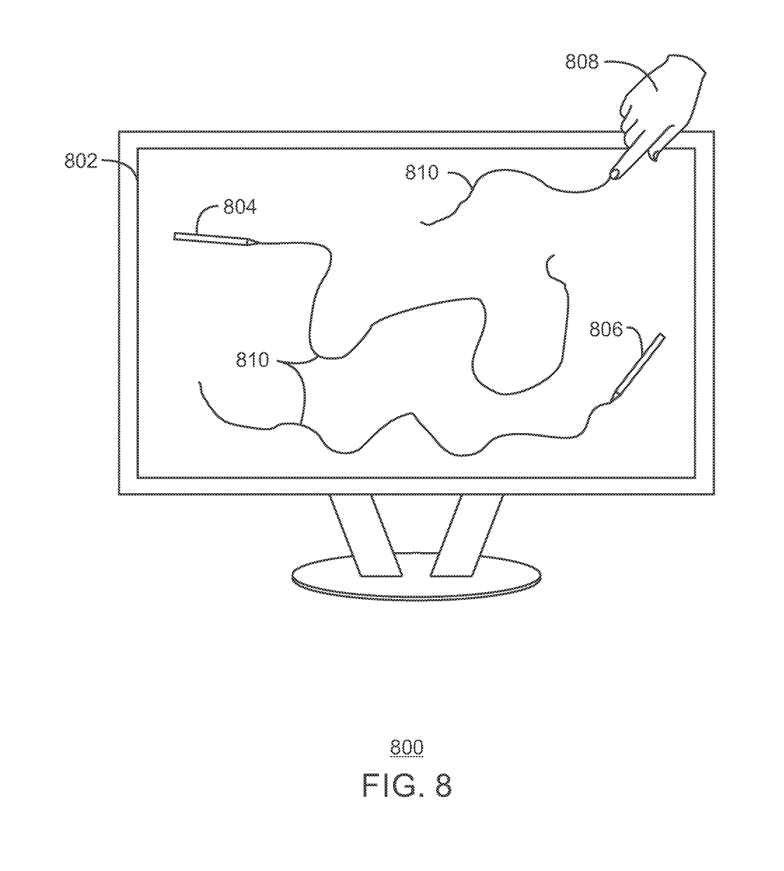

FIG. 8 is a drawing of a display 800 with a large touch screen 802. The display 800 may be part of an all-in-one computer system, or may be an independent input/output device, such as a monitor, configured for coupling to a standard desktop computer unit. In this embodiment, two styluses 804 and 806 and a finger touch 808 are shown providing input 810 to the device. The use of a plastic for the display panel cover, such as PMMA, may reduce the total display weight by about 7% or more. Further, the use of an appropriately selected plastic cover panel can reduce the backlight power by about 5%, for example, by decreasing internal reflections. The use of dBEF, and/or separate prism can further reduce the backlight power by 45% or more. The use of a metal mesh touch detection system with 200 hz report rate can provide a 20 point, or more, touch detection and tracking, for example for a 60 cm or larger. As described herein, an active stylus system that supports six band frequencies can allow two styluses to simultaneously provide input. In some embodiments, the styluses can provide input simultaneously with touch inputs to allow further collaboration. The use of a direct bonding technique relieves mechanical stress on the plastic cover panel, increasing the strength of larger displays.

### EXAMPLE 1

In an example, a computing device includes a display panel cover permanently bonded to a sensor panel, wherein the display panel cover is a scratch resistant plastic material, and the sensor panel includes a touch sensor that can detect at least 15 simultaneous touch inputs on the display cover.

### EXAMPLE 2

In another example, a laminated display stack includes a plastic display panel cover, an adhesive layer, a touch sensor, a second adhesive layer, a stylus antenna, a third adhesive layer, and a display panel.

### EXAMPLE 3

In another example, a method for making a display is provided. The method includes affixing a touchscreen sensor to a display panel cover with an adhesive. A second adhesive is layered over the touchscreen sensor. A stylus antenna is affixed to the second adhesive layer over the touchscreen sensor. A third adhesive is layered over the stylus antenna. A display panel is affixed to the third adhesive layer over the stylus antenna.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A computing device comprising:
a display panel cover permanently bonded to a sensor panel, wherein the display panel cover is a scratch resistant plastic material; and
the sensor panel comprises a touch sensor that can detect at least 15 simultaneous touch inputs on the display cover.

2. The device of claim 1, comprising a portable all-in-one computer.

3. The device of claim 1, comprising a stylus antenna.

4. The device of claim 3, comprising a driver configured to scan the touch sensor at about 50 hertz before the detection of a touch and at about 200 hertz after the detection of a touch.

5. The device of claim 3, comprising a driver configured to six frequency bands and accept input from at least two styluses substantially simultaneously.

6. The device of claim 3, wherein the touch sensor and the stylus antenna are configured to allow both touch input and stylus input.

7. The device of claim 1, comprising a touchscreen of greater than about 50 cm in diagonal measurement.

8. The device of claim 1, comprising:
an interface to accept video signals from a computer; and
an interface to provide touchscreen input to the computer.

9. A laminated display stack, comprising
a plastic display panel cover;
an adhesive layer;
a touch sensor configured to detect at least 15 simultaneous touch inputs;
a second adhesive layer; and
a display panel.

10. The laminated display stack of claim 9, comprising
a stylus antenna coupled to the second adhesive layer; and
a third adhesive layer coupled to the display panel.

11. The laminated display stack of claim 9, wherein the plastic display panel cover comprises a polymethylmethacrylate (PMMA) polymer.

12. The laminated display stack of claim 9, wherein the plastic display panel cover comprises a polycarbonate, an acrylic polymer, or a transparent polymer.

13. The laminated display stack of claim 9, wherein the touch sensor comprises a wire mesh and wherein each wire is about 30 microns in diameter and each wire is spaced about 30 microns apart.

14. The laminated display stack of claim 9, wherein the display panel comprises a liquid crystal device display (LCD) panel.

15. The laminated display stack of claim 14, comprising a brightness enhancing film (BEF), a dual brightness enhancing film (dBEF), a prism film, or any combinations thereof.

16. The laminated display stack of claim 14, comprising a light source and a reflector.

17. The laminated display stack of claim 9, comprising an organic liquid crystal display (OLED).

18. A method for making a display, comprising:
affixing a touchscreen sensor to a display panel cover with an adhesive, wherein the touchscreen sensor comprises a metal mesh having a 30 micron separation between wires;
layering a second adhesive over the touchscreen sensor; and
affixing a display panel to the second adhesive layer.

19. The method of claim 18, comprising:
affixing a stylus antenna to the second adhesive layer over the touchscreen sensor;
layering a third adhesive over the stylus antenna; and
affixing a display panel to the third adhesive layer.

20. The method of claim 18, comprising assembling a display by placing the display panel over a brightness enhancing film, a prism film, a dBEF film, or any combinations thereof.

21. The method of claim 18, comprising placing the display panel over a light source.

22. The method of claim 18, comprising placing the display panel over a light source.

23. The method of claim 19, comprising:
coupling the display panel to a driver;
coupling the touchscreen sensor to a driver;
coupling the stylus antenna to a driver; and
mounting the display in a device.

24. A method for detecting a touch input on a touch screen, comprising:
scanning the touch screen at a first scan rate;
detecting a touch is present on the touch screen; and
increasing the scan rate to a second scan rate.

25. The method of claim 24, comprising increasing the scan rate for lines in the vicinity of the touch, while retaining a lower scan rate for lines not in the vicinity of the touch.

26. The method of claim 24, comprising detecting that a stylus input is present on the touch screen.

27. The method of claim 26, comprising responding to both the stylus input and the touch substantially simultaneously.
